(19) United States
(12) Patent Application Publication
(10) Pub. No.: US 2017/0284918 A1
(43) Pub. Date: Oct. 5, 2017

(54) AUTOMATED FLUID MONITORING

(71) Applicant: Schlumberger Technology Corporation, Sugar Land, TX (US)

(72) Inventors: Katherine Palazzo, Houston, TX (US); Christopher Leake, Stafford, TX (US); Anthony Scott Parker, Richmond, TX (US)

(21) Appl. No.: 15/086,444

(22) Filed: Mar. 31, 2016

(51) Int. Cl. G01N 11/04; E21B 47/00; E21B 43/267; E21B 43/26

(52) U.S. Cl. CPC G01N 11/04; E21B 43/26; E21B 47/00; E21B 43/267

(57) ABSTRACT

A method of monitoring characteristics of a viscosified fluid in a substantially continuous manner. Devices and techniques for such methods include use of an in-line Coriolis flowmeter to continuously circulate a portion of the viscosified fluid therein for analysis as the fluid may be directed to a blender for combining with a constituent such as proppant for forming a fracturing slurry. Devices and techniques herein allow for real-time monitoring and adjustment of the developing viscosified fluid and/or halting of the fracturing application depending on results of the ongoing monitoring.

### BACKGROUND

Exploring, drilling and completing hydrocarbon and other wells are generally complicated, time consuming and ultimately very expensive endeavors. As a result, over the years, well architecture has become more sophisticated where appropriate in order to help enhance access to underground hydrocarbon reserves. For example, as opposed to wells of limited depth, it is not uncommon to find hydrocarbon wells exceeding 30,000 feet in depth. Furthermore, today's hydrocarbon wells often include deviated or horizontal sections aimed at targeting particular underground reserves. Indeed, at targeted formation locations, it is quite common for a host of lateral legs and fractures to stem from the main wellbore of the well toward a hydrocarbon reservoir in the formation.

The above described fractures may be formed by a fracturing operation, often referred to as a stimulation operation. The stimulation or fracturing operation, involves pumping of a fracturing fluid at high pressure into the well in order to form the fractures and stimulate production of the hydrocarbons. The fractures may then serve as channels through the formation through which hydrocarbons may reach the wellbore. The indicated fracturing fluid generally includes a solid particulate or aggregate referred to as proppant, often sand. The proppant may act to enhance the formation of fractures during the fracturing operation and may also remain primarily within fractures upon their formation. In fact, the fractures may remain open in part due to their propping open by the proppant.

In order to deliver proppant to the fractures in the application as indicated, a fracturing fluid that is a blended mixture of the proppant and other constituents with a linear fluid is utilized. Specifically, a linear fluid formed from water or a non-Newtonian fluid, guar and other potential additives is provided to a blender along with the proppant and remaining constituents. Once at the blender, the linear fluid may undergo cross-linking and become a highly viscous, more gel-like character for suspending the proppant and other constituents therein. Thus, the intended fracturing fluid is rendered. Utilizing fracturing fluid with this character provides a level of control over the proppant to help ensure that it is delivered to a targeted downhole location, such as a fracture, as opposed to merely falling out of suspension and dropping to the bottom of the well or other unregulated location.

In order for the fracturing fluid to take on this proper character and hold the proppant, the linear fluid that is provided to the blender should be of a predetermined viscosity. That is, to ensure that the proper cross-linking takes place during forming of the fracturing fluid, it is important that the linear fluid be of the proper pre-determined viscosity. So, for example, the application may call for a linear fluid that includes 20-40 lbs. of guar per every thousand gallons of water. In this example, a mixer may be used where the guar and other constituents are mixed with water as called for to form the linear fluid in advance of it being sent to the blender for combining with proppant and forming the fracturing fluid.

As indicated, the application may call for a particular protocol of a predetermined amount or rate of guar and other constituents to be added to the water in forming the linear fluid. Of course, there is always the possibility of operator or equipment error in carrying out the protocol or even the possibility that the called for protocol itself is in error. As alluded to above, if this happens, the linear fluid may end up being too thin or not viscous enough to ultimately provide a fracturing fluid capable of properly “holding” the proppant. When this occurs, the application may not only fail but it could result in dropping a sufficient amount of proppant into the well so as to require stopping operations and performing a cleanout at a cost of a day or more in lost time, not to mention added application expenses of a million dollars or more. Alternatively, if the linear fluid becomes too viscous, it may not be workable for the operators, thus preventing the forming of the fracturing fluid in the first place. Thus, at a minimum, operations would still be brought to a halt.

In order to help ensure that operations are not halted or worse, the linear fluid is periodically sampled during operations and evaluated. Specifically, the sampled fluid is checked for viscosity being within tolerances. Additionally, other characteristics such as temperature and acidity may be checked. Regardless, evaluating the sample involves taking the sample from the mixer for evaluation at a separate locale. This is because checking the linear fluid viscosity by conventional modes requires that a discrete amount of the linear fluid be placed within an isolated cup or chamber where an implement may be rotated or moved therein and monitored for torque. In this way, the torque reading may be translated into a useful viscosity reading for the operator.

Unfortunately, taking the sample to another locale for sake of ascertaining the viscosity reading means that operations are proceeding in the interim with the linear fluid as is. That is, should the operator determine that there is a viscosity or other issue, a potentially large quantity of linear fluid and ultimately faulty fracturing fluid may have been pumped downhole. Indeed, as a practical matter, it is often more likely that the operator will be alerted of an issue with the fracturing fluid due to a noticeable fluid pressure change or other event as opposed to being alerted of an out of spec linear fluid sample. That is, once the linear fluid is determined to be fully out of specification by conventional viscosity related sampling, it may be too late to prevent the pumping improper fracturing fluid downhole.

### SUMMARY

A method of monitoring one or more characteristics of a viscosified fluid is detailed herein. The method takes place in a substantially continuous and automated fashion during running of an application at an oilfield that utilizes the fluid. Specifically, the fluid is formed at a mixer and transported to a blender for combining with a proppant to form a fracturing fluid for a fracturing application. However, simultaneously, a portion of the viscosified fluid is also transported to a monitoring unit which acquires dynamic information regarding a characteristic of the fluid in a real-time manner during the application.

### BRIEF DESCRIPTION OF THE DRAWINGS

FIG. 1A is a perspective view of an embodiment of a viscosified fluid monitoring unit.

FIG. 1B is a schematic block diagram of an embodiment of a viscosified fluid monitoring unit.

FIG. 2 is an overview of an oilfield with equipment for running an application in a well thereat with a fracturing fluid obtained from the viscosified fluid.

FIG. 3A is a perspective view of an embodiment of a flowmeter of the unit of FIG. 1A.

FIG. 3B is a cross sectional view of the flowmeter of FIG. 3A revealing an embodiment of a pendulum and measuring tube assembly.

FIG. 3C is a perspective view of the pendulum and measuring tube assembly of FIG. 3B for determining viscosity of a viscosified fluid therethrough.

FIG. 4 is a schematic view of an embodiment of a mixer for forming viscosified fluid.

FIG. 5 is a flow chart summarizing an embodiment of employing a viscosified fluid monitoring unit on a substantially continuous basis during an oilfield application.

### DETAILED DESCRIPTION

In the following description, numerous details are set forth to provide an understanding of the present disclosure. However, it will be understood by those skilled in the art that the embodiments described may be practiced without these particular details. Further, numerous variations or modifications may be employed which remain contemplated by the embodiments as specifically described.

Embodiments are described with reference to certain embodiments of oilfield operations. Specifically, stimulation operations involving fracturing of a well are detailed herein. However, other types of oilfield operations may benefit from the equipment and techniques detailed herein. For example, a monitoring unit as described may be utilized to monitor fluid characteristics of other application fluids, including those of potentially variable viscosities. Indeed, so long as fluid characteristic information is monitored in a substantially continuous and real-time manner while the fluid is also utilized in an application, appreciable benefit may be realized, particularly where the characteristic is one of potentially changing or dynamic viscosity of the fluid.

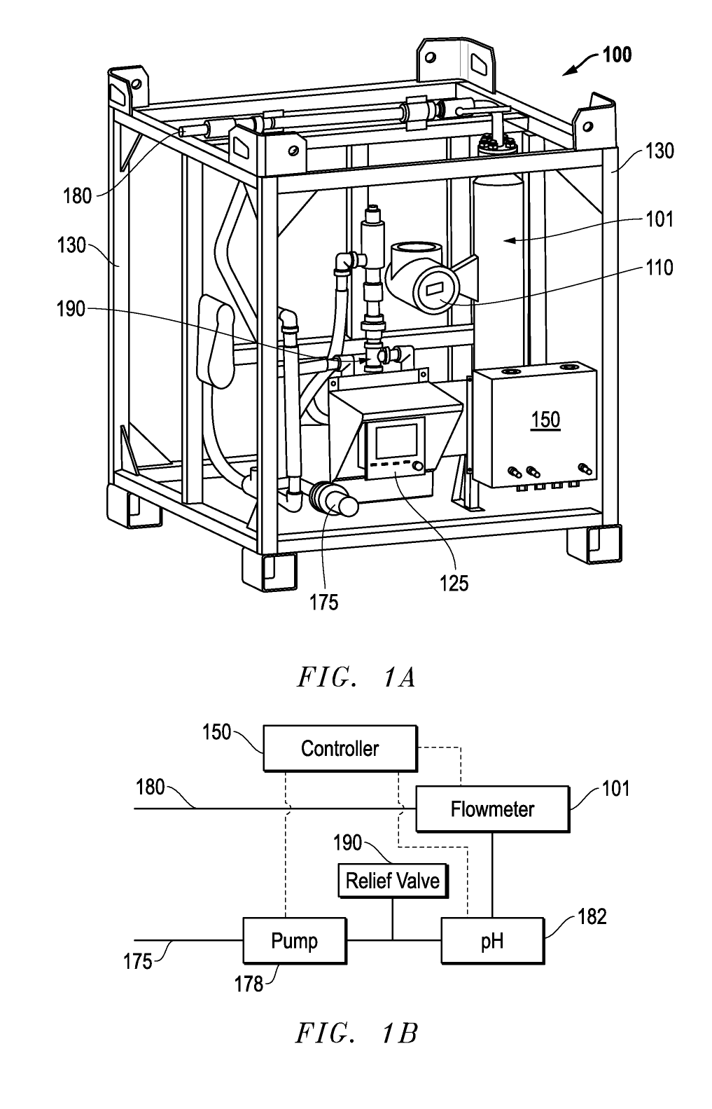

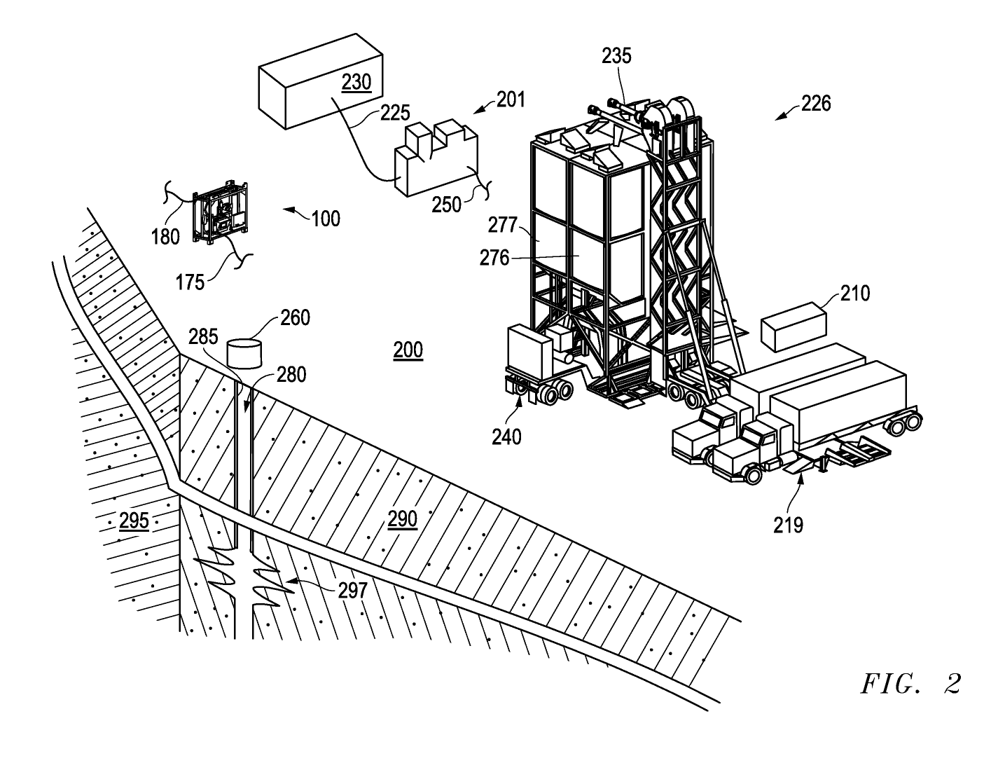

Referring now to FIG. 1A, a perspective view of an embodiment of a viscosified fluid monitoring unit 100 is shown. The unit 100 includes a frame 130 for accommodating a host of devices and features in a stand-alone, modular manner at a worksite such as the oilfield 200 shown in FIG. 2. In the embodiment shown, the frame 130 is of a standard tote tank configuration that may be about 3 to 5 feet tall and serves a protective function relative devices and features secured therein. As suggested, the unit 100 is tailored to monitor characteristics of a viscosified fluid that is to be employed at the worksite. In particular, the unit 100 is able to provide real-time information about such a fluid, including relative its potentially fluctuating viscosity, as the fluid is being utilized in an application at the worksite.

Thus, along these lines, the unit 100 includes a fluid intake 175, in-line flowmeter 101 and fluid outlet 180. In this manner, a portion of a mixed viscosified fluid may be routed to the unit 100 for real-time analysis as the fluid is also employed in an application as noted above. As detailed below, the in-line flowmeter 101 is a Coriolis instrument capable of determining characteristics of the mixed fluid even though the fluid may not be a water based fluid (e.g. a non-Newtonian fluid). Further, the “in-line” nature of the flowmeter 101 allows for ongoing real-time analysis as opposed to periodic sampling with delayed results. Also, among the characteristics which may be reliably ascertained by aid of the flowmeter 101, is the viscosity of the mixed fluid. Therefore, as also detailed below, the unit 100 may be utilized to help ensure that the fluid is of an intended viscosity for the worksite application without the need to rely on lagging manual periodic sampling.

Continuing with reference to FIGS. 1A and 1B, the in-line flowmeter 101 includes a screen or display 110 where certain fluid related readings may be displayed as acquired by the flowmeter 101. Further, these and other fluid related readings may be shown at a larger screen or display 125. For example, in an embodiment, the larger display 125 may provide pH readings whereas the screen 110 may provide density, temperature, flow rate, viscosity or other fluid related readings ascertainable from the flowmeter 101 as detailed below. In this embodiment, a pH probe 182 (see FIG. 1B) may transect piping leading to the flowmeter 101 to allow for standard readings of up to 14 pH thereof at the adjacent display 125.

As indicated above, the flowmeter 101 is not only in-line to allow for ongoing and substantially continuous readings as opposed to periodic sampling but it is also of a Coriolis variety to allow for reliable analysis when the viscosified fluid is a non-Newtonian fluid. In an embodiment, this ongoing feed of a portion of the viscosified fluid for the analysis is supported by a hydraulic or electric motor and pump assembly 178, best seen in FIG. 1B. In the embodiment shown, these assembly components may be positioned on the unit 100 roughly behind the visible display 125, though alternative locations may be employed. Once more, the pump 178 itself may have a rating of about 200-350 PSI and constitute the only moving equipment part of the unit 101. In an embodiment, a pop-off or relief valve 190 may be disposed downstream of the pump 178 to relieve pressure above a predetermined limit in the lines between the pump 178 and the pH probe 182, the flowmeter 101 and the outlet 180.

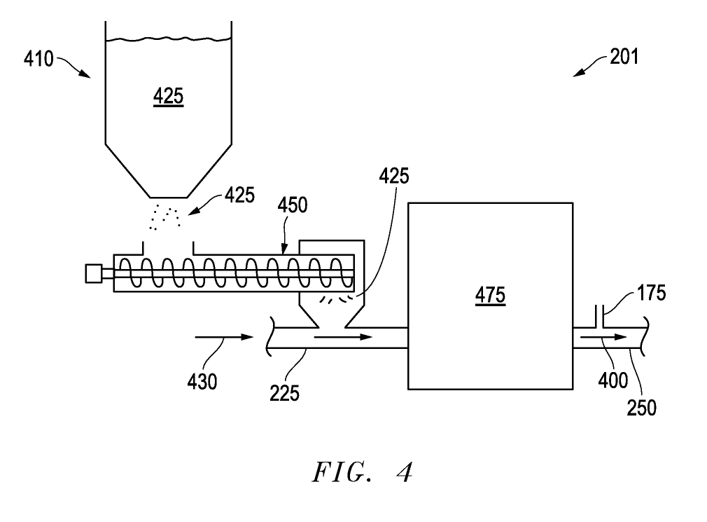

Regardless of the particular configuration, the assembly may be utilized to draw in between about 5 and 15 gallons of viscosified fluid per minute on an ongoing, substantially continuous basis. Of course, in other embodiments, different flow rates may be pumped through the unit 100. So long as the viscosified fluid is run through the flowmeter 101 continuously and in an amount sufficient for the flowmeter 101 to ascertain readings as detailed herein, appreciable benefit may be realized. As alluded to above and with added reference to FIGS. 2 and 4, this portion of the viscosified fluid is drawn into the unit 100 from a mixer 201 where it is formed by way of the inlet 175 which behaves as a suction port. It is then analyzed as described above and returned to circulation via the outlet 180.

As detailed further below, the unique nature of the in-line Coriolis flowmeter 101 is such that information obtained relative the viscosified fluid may be further processed in order to render a meaningful viscosity value. Thus, a controller 150 (which may be disposed in a box or the like as shown in FIG. 1A) may include hardware and/or software particularly tailored for such conversions in conjunction with managing acquired data. Additionally, the controller 150 may be operatively connected to the pump 178, the pH probe 182, the flowmeter 101 (see FIG. 1B) and other devices of the unit 100 for receiving information from and/or transmitting information and/or commands to the pump 178, the relief valve 190, the pH probe 182, and the flowmeter 101 and other devices of the unit 100 during operation of the unit 100.

In an embodiment, the unit 100 also serves a filtering function for the diverted, recently mixed viscosified fluid to be analyzed by the flowmeter 101. Specifically, to eliminate potentially larger impurities from the fluid, a replaceable 2-20 mesh in-line filter may be placed between the inlet 175 and the flowmeter 101. In this way, an analysis of the fluid may take place that is not obscured by random debris that might skew readings or compromise the flowmeter detections.

Referring now to FIG. 2, an overview of an oilfield 200 is shown with equipment for running an application in a well 280. In the embodiment shown, the application is a fracturing application directed at a production region 297 in the well 280. Thus, a fracturing fluid or slurry is obtained from a blender 240 where proppant from a proppant storage device such as, but not limited to, a multi-silo assembly 226 and viscosified fluid from the mixer 201 are combined. Of course, other constituents besides proppant may be added to the fluid at the blender 240, for example, to support applications other than fracturing in the well 280. Regardless, as detailed above, the viscosified fluid is itself formed at the mixer 201 and analyzed by the unit 100 as detailed hereinabove. More specifically, the unit 100 is utilized to ensure that the viscosified fluid is of the right viscosity and other predetermined characteristics. In this way, for the embodiment shown, the fracturing slurry which is formed at the blender 240 may be better assured of performing as intended, for example properly reaching perforations of the production region 297 as opposed to dropping proppant into the bottom of the well 280.

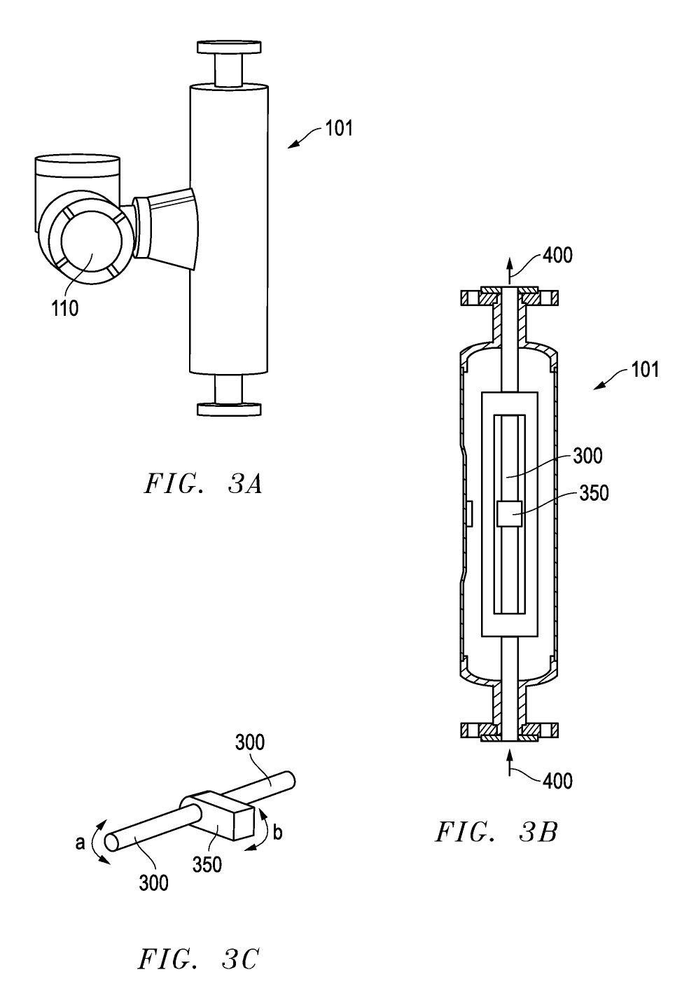

Continuing with reference to FIG. 2, the well 280 is outfitted with casing 285 and traverses various formation layers 290, 295 before reaching the production region 297, potentially several thousand feet below the oilfield 200. Thus, as suggested above, ensuring parameters of the application are met plays a vital role in achieving a proper placement and effectiveness of the fracturing slurry. In large part, this includes monitoring the development of the viscosified fluid during operations. Therefore, in the embodiment shown, as a base fluid is taken from a fluid tank 230 and directed over a base line 225 to the mixer 201 and combined with a viscosifying agent 425, characteristics of the resulting mixed viscosified fluid are analyzed in real-time (see FIG. 4). Once more, even though the fluid from the tank may be non-Newtonian in nature, an in-line flowmeter 101 may be employed to acquire readings that may be used in determining fluid viscosity in a real-time, ongoing and substantially continuous manner as detailed below (see FIGS. 3A-3C).

The above detailed unit 100 is positioned at the oilfield 200 adjacent the mixer 201. Thus, as the viscosified fluid is directed from a discharge port of the mixer 201 and over a linear gel line 250 toward the blender 240 as described above, a portion thereof is also simultaneously directed over the intake line 175 to the unit 100 for the noted real-time analysis. In the embodiment shown, the analyzed fluid is also then returned back to the gel line 250 or other circulation point and eventually routed over to the blender 240.

In the embodiment shown, proppant is delivered to the oilfield 200 by delivery trucks 219. The blender 240 then obtains proppant and potentially other additives from a host of silos 276, 277 of the assembly 226 via arms 235. Thus, the blender 240 may combine these constituents with the viscosified fluid from the gel line 250 as directed by an operator from a control station 210. The control station 210 may comprise a controller or the like for real-time control of the various components of the fluid monitoring unit 100, the mixer 201, the assembly 226, and the like. With real-time assurances acquired from the unit 100 as to the proper characteristics of the viscosified fluid, the blended fracturing slurry may take on a more cross-linked character suitable for use downhole in the fracturing application. More specifically, as detailed above, during a fracturing application, the monitored fracturing slurry, may be directed past a wellhead 260 and into the well 280 for placement within perforations of the targeted production region 297. In an embodiment, the viscosified fluid from the gel line 250 is routed directly to the wellhead 260 and the well 280 and bypasses the blender 240 and the assembly 226 entirely.

Referring now to FIGS. 3A-3C, with added reference to FIGS. 2 and 4, the in-line flowmeter 101 and techniques associated therewith may be key to the ability to assure achieving proper specification tolerances for the viscosified fluid that is provided to the mixer 240 in the first place. As noted, the flowmeter 101 is of an in-line, Coriolis variety, such as, but, not limited to, those commercially available from Endress+Hauser, Inc., and capable of determining viscosity of the mixed fluid in circumstances where the fluid is non-Newtonian in nature, such as where a polymer solution is utilized as the base fluid from the tank 230. Specifically, as a viscosifying agent 425 such as guar, is added to the fluid at the mixer 201 according to a predetermined protocol, the viscosity of the fluid is increased in a linear fashion before advancing on to the blender 240. However, as indicated above, a flowmeter 101 of a monitoring unit 100 is also simultaneously utilized to ensure that the now viscosified fluid is within tolerances for the fracturing slurry to be formed at the blender 240. FIG. 3A, in particular depicts an enlarged perspective view of the flowmeter 101 of the unit 100 for determining viscosity by way of fluid shear rate determinations which may be applicable to Newtonian and non-Newtonian fluids alike.

As detailed above, the flowmeter 101 may include a screen 110 where viscosified fluid characteristics may be provided to an operator. Among these characteristics may be density, temperature and flow. However, perhaps most notably is the ability to dynamically attain an accurate viscosity reading for the viscosified fluid.

Referring specifically to FIG. 3B, a cross sectional view of the flowmeter 101 of FIG. 3A is shown. In this view, pendulum 350 and measuring tube 300 devices are apparent which may be utilized to acquire viscosity from the portion of the viscosified fluid that is routed therethrough. More specifically, as the viscosified fluid is taken in by the monitoring unit 100, it is sent through the tube 300 while a torsional movement is imparted on the tube 300 by the pendulum 350. For example, in the perspective view of the tube 300 and pendulum 350 of FIG. 3C, this oscillating movement (arrows a, b) is apparent.

The torsional movement described above creates a velocity profile for the viscosified fluid passing through the tube 300. This profile in turn may be recorded and processed, for example at the adjacent controller box 150 of FIG. 1. Further, as with any other reading by the flowmeter 101 such as temperature or flow rate, the viscosity may be dynamic for the viscosified fluid. This may be accounted for by dampening the oscillating movement and/or a requirement more power on the pendulum as the fluid becomes more viscous or vice versa as the fluid becomes thinner. Either way, the potentially changing viscosity of the fluid may be reliably acquired and recorded in a substantially continuous fashion. Further, this viscosity determination may be practically applied to non-Newtonian fluids in an in-line, ongoing manner given that they are not reliant on the use of a bent flow meter or other technique that might be unable to acquire such viscosity readings from non-Newtonian fluids. That said, the readings that are obtained may be acquired at shear rates that are outside of industry standards of say 511 or 170. For example, the shear rate of the depicted flowmeter 101 via the torsion described may be at about 325. Nevertheless, operators may be provided with a conversion table or the readings converted at the controller box 150 of FIG. 1 such that a user-friendly viscosity reading is made available to the operator.

It is worth noting that by determining viscosity in the manner described above, ongoing readings are available, even for non-Newtonian fluids, without the need to utilize delayed periodic manual sampling. Instead, the changing viscosity is immediately available to the operator and may be depicted at the screen 110 at another suitable location such as the control station 210, or be provided to the controller 150 for the system 100. Thus, the operator may halt operations if the determined viscosity specifications are found to be substantially outside of predetermined tolerances. Alternatively, the real-time dynamic viscosity readings may be sufficient to alert the operator of viscosity trends toward upper or lower tolerated viscosity bounds. Thus, the operator may be afforded the opportunity to adjust the application at the mixer 201. For example, the operator may have time to adjust the rate of adding viscosifying agent 425 or to alter pH levels or take other measures before the viscosified fluid falls fully outside of predetermined tolerance levels (see FIG. 4).

Referring now to FIG. 4, with added reference to FIG. 2, a schematic view of an embodiment of the mixer 201 is shown. The mixer 201 is employed for forming the viscosified fluid 400 as detailed hereinabove. Specifically, a viscosifying agent 425 such as guar may be supplied from a feeder 410 toward a mixing unit 475. In the embodiment shown, an auger mechanism 450 is utilized to advance the agent 425 into intersection with the fluid base line 225. The base fluid 430 from the fluid tank 230 is thus, advanced with the agent 225 to the unit 475 where it is mixed as described above and emerges as the viscosified fluid 400 and advanced to the blender 240. As also detailed above, a portion of the mixed viscosified fluid 400 is also circulated over to the monitoring unit 100 via the intake line 175.

Continuing with reference to FIGS. 2 and 4, given the real-time monitoring available to the operator, adjustments may be made at the mixer level depending on the resulting analysis. So, for example, where the mixer level application calls for the addition of about 20-40 lbs. of agent 425 per about 1,000 gallons of base fluid 430, it may be determined at the unit 100 that the resultant viscosity is trending toward the lower tolerance limit. Thus, the operator may take action, for example, to ensure that the auger mechanism 450 or adjacent features are functioning properly for the proper add rate. Further, where the add rate is determined to be following the predetermined protocol but the viscosity readings continue to trend low, the operator may increase the add rate, for example to compensate for the unanticipated properties being displayed by the guar agent 425. Indeed, from one batch to another of agent 425, this may be the case from time to time. Nevertheless, due to the continuous, uninterrupted monitoring, the operator is provided with the opportunity to adjust the add rate in real-time without materially adverse downstream effect on the application. During operation, the pH readings available from the pH 182 probe may be monitored and a change in the pH level may be indicative of a cause of an undesirable viscosity or the like.

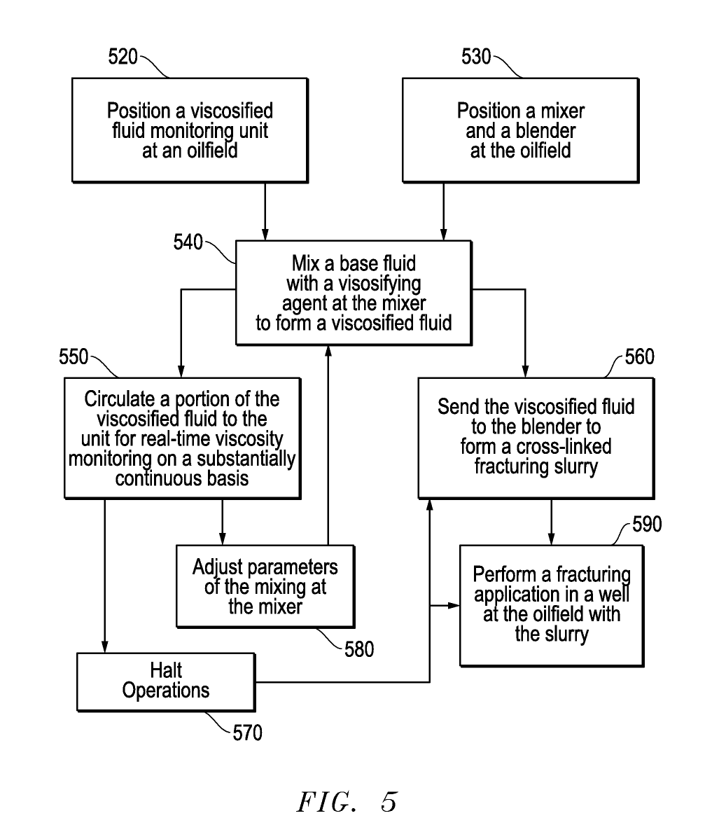

Referring now to FIG. 5, a flow chart is shown summarizing an embodiment of employing a viscosified fluid monitoring unit on a substantially continuous basis during an oilfield application. Specifically, the unit is positioned at an oilfield along with a mixer and a blender as indicated at 520 and 530, respectfully. The mixer may be used to mix a base fluid with a viscosifying agent to form a viscosified fluid as indicated at 540. As with other conventional oilfield operations, the viscosified fluid may be sent to a blender (see 560), for example, to add a proppant and attain a cross-linked fracturing slurry for use in a fracturing application in a well (see 590).

However, the presence of the monitoring unit at the oilfield also allows for monitoring of the viscosified fluid for characteristics such as viscosity as indicated at 550. Indeed, this may take place at the same time that the viscosified fluid is being sent to the blender. As a result, where characteristics such as viscosity are determined to be materially out of specification, the operations may be halted altogether as indicated at 570, either by stopping the blending or the fracturing. Alternatively, however, where the viscosified fluid exhibits characteristics that are trending away from ideal specifications but not sufficient to warrant halting operations, adjustments may be made at the mixer (see 580). For example, the operator may increase or decrease the rate of add to the viscosifying agent to the base fluid.

Embodiments described above allow for real-time dynamic monitoring of viscosity and other characteristics of a viscosified fluid. More specifically, a viscosified fluid such as a linear gel utilized in on-site development of a fracturing slurry may be continuously monitored as the slurry is developed to ensure that gel characteristics remain within predetermined specifications. In an embodiment, real-time dynamic monitoring of viscosity and other characteristics of a viscosified fluid may be utilized to analyze other viscosified fluids, such as drilling mud or the like. This takes place in a real-time, automated fashion as opposed to requiring intermittent manual sampling which inherently involves a lag or delay in obtaining such results. Notably, the monitoring unit which is utilized in attaining this up to the moment dynamic information regarding the fluid is able ascertain viscosity as one of the continuously monitored characteristics without any substantial lag or delay. Thus, operators may be alerted of any out of specification viscosity readings in real-time to allow for immediate operational adjustments or halting of operations if needed so as to prevent potential major or catastrophic application-related developments.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. A method of monitoring a characteristic of a viscosified fluid, the method comprising:
adding, at a given rate, a viscosifying agent to a fluid base at a mixer to form the viscosified fluid for an application at a well at an oilfield;
transporting a portion of the viscosified fluid to a monitoring unit at the oilfield simultaneous with the transporting to the well in a substantially continuous manner during the application; and
employing the monitoring unit to acquire dynamic information regarding the characteristic in an automated manner during the substantially continuous transporting of the portion of the viscosified fluid thereto.

2. The method of claim 1 further comprising
transporting the viscosified fluid from the mixer to a blender;
combining with the viscosified fluid with a constituent to form a slurry for an application in a well at an oilfield, wherein the combining of the constituent with the viscosified fluid provides the slurry with a cross-linked character.

3. The method of claim 2 wherein the slurry is a fracturing slurry and the application in the well is a fracturing application.

4. The method of claim 1 further comprising analyzing the dynamic information regarding the characteristic against predetermined upper and lower bounds of acceptability for the characteristic in light of the application.

5. The method of claim 4 wherein the characteristic is viscosity of the viscosified fluid, the method further comprising:
determining from the analyzing that the viscosity of the fluid is trending toward the lower bound; and
one of ensuring that the given rate of the adding is occurring and increasing the given rate of the adding.

6. The method of claim 4 wherein the characteristic is viscosity of the viscosified fluid, the method further comprising:
determining from analyzing that the viscosity of the fluid is trending toward the upper bound; and
decreasing the given rate of adding.

7. The method of claim 4 further comprising:
determining that the characteristic is outside of one of the upper and lower bounds of acceptability; and
halting the application.

8. The method of claim 1 wherein the characteristic is viscosity and employing of the monitoring unit comprises:
routing the portion of the viscosified fluid through a measuring tube of a flowmeter of the unit;
applying a torsional movement on the measuring tube by a pendulum during the routing of the portion of the fluid therethrough; and
attaining a dynamic viscosity of the fluid based on changes in power requirements necessary to attain the torsional movement by the pendulum.

9. The method of claim 8 wherein the reading is provided based on a non-industry standard shear rate, the method further comprising one of:
providing an operator with at least one conversion chart for converting the reading to an industry standard shear rate; and
utilizing a processor to convert the reading to an industry standard shear rate for the operator.

10. A viscosified fluid monitoring unit comprising:
a fluid intake line for receiving a portion of a viscosified fluid from a mixer forming the fluid from a base fluid and a viscosifying agent;
a fluid outlet line for returning the portion of the viscosified fluid to a circulating flow of viscosified fluid; and
an in-line Coriolis flowmeter to circulate the portion of the viscosified fluid from the fluid intake line to the fluid outlet line and provide ongoing, substantially continuous monitoring of a characteristic of the viscosified fluid.

11. The unit of claim 10 wherein the characteristic of the viscosified fluid is viscosity, the flowmeter further comprising:
a measuring tube to accommodate the circulating portion of the viscosified fluid therethrough; and
a pendulum to impart a torsional movement on the tube during the circulating for establishing the viscosity.

12. The unit of claim 10 further comprising a standalone modular frame for accommodating the flowmeter at a worksite.

13. The unit of claim 10 further comprising a pump for operating at a substantially constant rate to draw the portion of the fluid into the intake line.

14. The unit of claim 10 wherein the fluid outlet line is in fluid communication with a blender for forming an application fluid from the viscosified fluid and at least one added constituent.

15. The unit of claim 10 further comprising a secreen secured to the flowmeter for displaying the characteristic to an operator and wherein the characteristic is one of density, temperature, flow rate, and viscosity of the portion of the viscosified fluid.

16. The unit of claim 10 further comprising a pH probe transecting the inlet line to the flowmeter.

17. The unit of claim 16 further comprising a display to provide pH readings from the probe to an operator.

18. A system at an oilfield accommodating a well, the system comprising:
a tank for holding a base fluid;
a mixer for combining the base fluid with a viscosifying agent to form a viscosified fluid;
a blender for combining the viscosified fluid with a constituent to form an application slurry directed at the well; and
a viscosified fluid monitoring unit with an in-line Coriolis flowmeter to monitor a characteristic of a portion of the viscosified fluid on a substantially continuous basis as the viscosified fluid is transported to the blender.

19. The system of claim 18 wherein the characteristic of the viscosified fluid is viscosity, the monitoring unit including a flowmeter comprising:
a measuring tube to accommodate the circulating portion of the viscosified fluid therethrough; and
a pendulum to impart a torsional movement on the tube during the circulating for establishing the viscosity.

20. The system of claim 18 wherein the base fluid is a non-Newtonian fluid, the viscosifying agent is guar and the constituent is proppant.
